(19) United States
(12) Patent Application Publication
(10) Pub. No.: US 2025/0372748 A1
(43) Pub. Date: Dec. 4, 2025

(54) METHOD FOR TREATING BATTERY MEMBER

(71) Applicant: HONDA MOTOR CO., LTD., Tokyo (JP)

(72) Inventors: Yushi FUJINAGA, Saitama (JP); Hideki MATSUDA, Saitama (JP); Akihito NINOMIYA, Saitama (JP)

(21) Appl. No.: 18/873,738

(22) PCT Filed: Aug. 2, 2023
(86) PCT No.: PCT/JP2023/028278

§ 371 Date: Dec. 11, 2024

(30) Foreign Application Priority Data
Sep. 2, 2022 (JP) 2022-140038

(51) Int. Cl. H01M 10/54; C22B 3/22; C22B 7/00; C22B 26/12; H01M 10/0525

(52) U.S. Cl. CPC H01M 10/54; C22B 3/22; C22B 7/001; C22B 26/12; H01M 10/0525

(57) ABSTRACT

Provided is a method that is for treating a battery member containing a sulfide, and that is capable of effectively removing hydrogen sulfide generated when the battery member is brought into contact with a treatment liquid. The method is for treating a battery member containing lithium metal and a sulfide, the method comprising: a nitrification step S1 for bringing the battery member into contact with nitrogen gas to obtain a substance containing lithium nitride and the sulfide; and a treatment step S2 for bringing the substance containing lithium nitride and the sulfide into contact with a treatment liquid containing water.

### TECHNICAL FIELD

The present invention relates to a method for treating a battery member.

### BACKGROUND ART

Batteries such as lithium ion secondary batteries are used as a power source mounted in a hybrid vehicle or an electric vehicle. In recent years, a rapid increase has been expected in used batteries for automobiles, batteries discarded as defective products at the time of battery manufacturing, and the like. Such batteries contain valuable substances such as lithium. For effective use of resources, a method for recovering valuable substances from such batteries has been proposed.

For example, Patent Document 1 describes a technique for recovering metallic lithium by converting metallic lithium having unnecessary formations formed on its surface into lithium chloride and electrolyzing molten lithium chloride. Patent Document 1 describes that this method can recover metallic lithium even if the metallic lithium has unnecessary formations formed on its surface.

Patent Document 2 describes a method for treating a battery member containing at least a sulfide solid electrolyte material having Li (lithium) and P (phosphorus), the method including bringing the battery member and a treatment liquid containing water into contact with each other to generate hydrogen sulfide, dissolving Li in the treatment liquid, recovering a positive electrode active material from the treatment liquid, and drying the treatment liquid from which the positive electrode active material was recovered to recover a Li compound. Patent Document 2 describes that the positive electrode active material and the sulfide solid electrolyte material can be efficiently separated from each other, and the positive electrode active material and Li contained in the sulfide solid electrolyte material can be efficiently recovered.

### CITATION LIST

### Patent Document

Patent Document 1: Japanese Unexamined Patent Application, Publication No. 2012-87404
Patent Document 2: Japanese Patent No. 5062262

### DISCLOSURE OF THE INVENTION

### Problems to be Solved by the Invention

When the metallic lithium is recovered from the battery member, the lithium contained in the battery member is dissolved by bringing the battery member into contact with the treatment liquid, and separated from an insoluble component such as the active material contained in the battery member.

However, if the battery member contains sulfide, hydrogen sulfide is generated when the battery member is brought into contact with the treatment liquid. In this case, it is necessary to provide equipment or the like for recovering the generated hydrogen sulfide, a result of which maintenance of the equipment is expensive and productivity declines.

An object of the present invention is to provide a method for treating a battery member capable of effectively suppressing the generation of hydrogen sulfide when a battery member containing sulfide is brought into contact with a treatment liquid.

### Means for Solving the Problems

As a result of intensive studies, the present inventors have found that the above problems can be solved by bringing a battery member into contact with nitrogen gas to obtain a substance containing lithium nitride and sulfide, and bringing the substance into contact with a treatment liquid, thereby arriving at completion of the present invention.

The present invention provides a method for treating a battery member containing lithium metal and a sulfide, the method including: a nitriding step of bringing the battery member into contact with a nitrogen gas to obtain a substance containing lithium nitride and sulfide; and a treatment step of bringing the substance containing the lithium nitride and the sulfide into contact with a treatment liquid containing water.

With such a configuration, it is possible to effectively suppress the generation of hydrogen sulfide when a battery member containing sulfide is brought into contact with the treatment liquid.

The battery member may further contain a ternary positive electrode material, and the treatment liquid may be an alkali aqueous solution.

The battery member may further contain copper metal, stainless steel and aluminum, and the treatment liquid may be an alkali aqueous solution.

The battery member may be derived from a solid-state battery containing lithium metal and a solid electrolyte containing sulfide.

### Effects of the Invention

According to the present invention, it is possible to effectively suppress the generation of hydrogen sulfide even when a battery member containing sulfide is brought into contact with a treatment liquid.

### BRIEF DESCRIPTION OF THE DRAWINGS

FIG. 1 is a step diagram showing an example of the flow of a method for treating a battery member of a solid-state battery.

### PREFERRED MODE FOR CARRYING OUT THE INVENTION

Hereinafter, specific embodiments of the present invention will be described in detail, but the present invention not to be in any way limited to the following embodiments, and can be implemented with appropriate modifications within the scope of the object of the present invention.

### 1. SUMMARY

A method for treating a battery member according to the present invention is a method for treating a battery member containing lithium metal and sulfide. The method for treating a battery member includes at least a nitriding step of bringing the battery member into contact with nitrogen gas to obtain a substance containing lithium nitride and sulfide, and a treatment step of bringing the substance containing lithium nitride and sulfide into contact with a treatment liquid containing water.

As described above, by converting the lithium metal contained in the battery member into lithium nitride prior to the treatment step of bringing the battery member into contact with the treatment liquid, it is possible to effectively suppress the generation of hydrogen sulfide generated in the treatment step.

In the following, as one embodiment of the method for treating a battery member of the present invention, a method for recovering a lithium metal by taking out a battery member from a solid-state battery (all-solid battery) containing lithium metal and a solid electrolyte containing sulfide, and treating the battery member is described. In addition, the battery used in the method for treating a battery member according to the present invention is not limited to a solid-state battery (all-solid battery) containing a solid electrolyte, and may be a battery containing an electrolytic solution as an electrolyte or may be a polymer battery in which an electrolytic solution is contained in a polymer gel. Further, the battery used in the method for treating a battery member according to the present invention is not limited to a battery in which sulfide is contained in an electrolyte, and may be a battery in which sulfide is contained in a battery member (for example, an electrode, a separator, or the like) different from an electrolyte.

### 2. Method for Treating Battery Member of Solid-State Battery

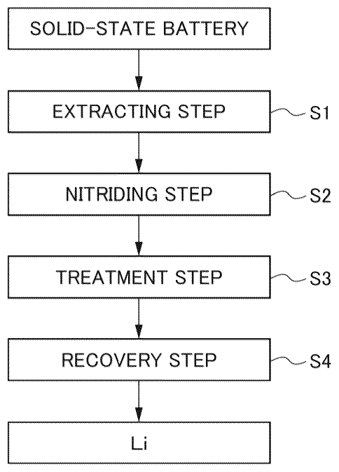

As shown in FIG. 1, the method for treating a battery member according to the present embodiment includes a extracting step S1 of extracting a battery member containing lithium metal and a solid electrolyte containing sulfide from a solid-state battery, a nitriding step S2 of bringing the battery member into contact with nitrogen gas to obtain a substance containing lithium nitride and sulfide, a treatment step S3 of bringing the substance containing the lithium nitride and sulfide into contact with a treatment liquid containing water, and a recovery step S4 of recovering valuable substances.

### 2-1. Extracting Step S1

In the extracting step S1, a battery member containing lithium metal and an electrolyte containing sulfide is extracted from the solid battery. Since a battery laminate constituting a solid-state battery is generally packaged in a package including a laminate film or the like, the battery laminate including valuable materials is opened and extracted from the package.

The extracting step S1 may be performed, for example, in the air, but the extracting step of taking out the battery laminate is preferably performed under a nitrogen atmosphere so that the battery member containing the lithium metal and the solid electrolyte containing sulfide is not brought into contact with a gas other than nitrogen gas as much as possible. A preferable range of the concentration of the nitrogen gas in the atmospheric gas at this time is the same as the preferable range of the concentration of the nitrogen gas in the nitriding step S2 described later.

A battery laminate constituting a solid-state battery includes a positive electrode layer, a negative electrode layer, and a solid electrolyte layer between the positive electrode layer and the negative electrode layer.

The positive electrode layer includes, for example, a positive electrode current collector and a positive electrode active material thereon. The positive electrode layer may contain a binder, a conductive additive, an electrolyte, and the like. The binder, the conductive additive, the electrolyte, and the like are not particularly limited, and a known substance as an electrode material of a secondary battery can be used.

The positive electrode active material is not particularly limited, and a known material as a positive electrode active material of a secondary battery can be applied. Examples of the positive electrode active material include laminar positive electrode active material particles such as LiCoO₂, LiNiO₂, LiNiO₂/LiCoO₂/LiMn₂O₄ (ternary positive electrode material), LiVO₂, and LiCrO₂, spinel positive electrode active materials such as LiMn₂O₄, Li(Ni_{0.25}Mn_{0.75})₂O₄, LiCoMnO₄ and Li₂NiMn₃)₈, and olivine positive electrode active materials such as LiCoPO₄, LiMnPO₄, and LifePO₄.

Among them, the positive electrode active material preferably contains a positive electrode active material which is a ternary positive electrode material such as LiNiO₂/LiCoO₂/LiMn₂O₄. When a positive electrode active material which is a ternary positive electrode material is used as the positive electrode active material, the battery member to be treated inevitably contains the ternary positive electrode material. Since the ternary positive electrode material does not dissolve in the alkali aqueous solution, bringing the treatment object into contact with the treatment liquid, which is the alkali aqueous solution, makes it possible to selectively dissolve only the lithium nitride and selectively recover the ternary positive electrode material.

The positive electrode current collector is not particularly limited, and a material known as a positive electrode current collector of a secondary battery can be used. Examples of the positive electrode current collector include aluminum and stainless steel. For example, aluminum, stainless steel, or the like molded into a foil shape is used. In addition to the above, a conductive carbon sheet (for example, a graphite sheet or a CNT sheet) or the like may be used.

The negative electrode layer includes, for example, a negative electrode current collector and a negative electrode active material thereon. In addition, the negative electrode layer may contain a binder, a conductive additive, an electrolyte, or the like. The binder, the conductive additive, the electrolyte, and the like are not particularly limited, and a known substance as an electrode material of a secondary battery can be used.

The negative electrode active material contains lithium metal. This is because, by using a negative electrode active material containing lithium metal, the lithium metal to be recovered is inevitably contained in the battery member to be treated.

In addition, the negative electrode active material may contain a negative electrode active material other than lithium metal. Examples of the negative electrode active material other than lithium metal include lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon and hard carbon, and metal indium and lithium alloys.

The negative electrode current collector is not particularly limited, and a material known as a negative electrode current collector of a solid-state battery can be applied. Among these, the negative electrode current collector preferably consists of at least one selected from the group including copper metal, stainless steel, and aluminum, and more preferably contains at least one selected from the group including copper metal and stainless steel. When a negative electrode current collector containing at least one selected from the group including copper metal, stainless steel, and aluminum is used, the battery member to be treated inevitably contains copper metal, stainless steel, and aluminum. Since copper metal or stainless steel does not dissolve in the alkali aqueous solution and aluminum dissolves in a strong alkali aqueous solution, it is possible to selectively dissolve only lithium nitride and selectively recover copper metal, stainless steel, or aluminum as an insoluble substance by bringing the treatment object into contact with a treatment liquid which is an alkali aqueous solution in a predetermined pH range.

The solid electrolyte layer includes a solid electrolyte containing sulfide. Examples of the solid electrolyte containing sulfide include those containing Li, S, and the third component A. Examples of the third component A include at least one selected from the group consisting of P, Ge, B, Si, I, Al, Ga, and As. In particular, it is preferable in the present invention that the sulfide solid electrolyte material is a compound made using Li₂S and a sulfide MS other than Li₂S. Specific examples thereof include a Li₂S—P₂S₅ compound, a Li₂S—SiS₂ compound, and a Li₂S—GeS₂ compound. In addition, the solid electrolyte layer may contain a solid electrolyte other than a sulfide. Examples of the solid electrolyte other than sulfide include an oxide-based solid electrolyte, a nitride-based solid electrolyte, and a halide-based solid electrolyte.

### 2-2. Nitriding Step S2

In the nitriding step S2, the battery member containing lithium metal mainly derived from the negative electrode active material and sulfide derived from the solid electrolyte layer is brought into contact with nitrogen gas. Thus, lithium metal is reacted with nitrogen gas to obtain a substance containing lithium nitride.

Bringing the substance containing lithium nitride into contact with a treatment liquid containing water in a treatment step described later makes it possible to generate ammonia ions, thereby effectively suppressing generation of hydrogen sulfide.

Examples of a method of bringing the battery member into contact with nitrogen gas include a method of loading and placing the battery member in a sealed container filled with nitrogen gas for a predetermined time. At this time, the concentration of the nitrogen gas in the atmosphere gas in the sealed container is preferably 90% by volume or more, more preferably 95% by volume or more, and still more preferably 99% by volume or more.

The temperature at which the battery member is brought into contact with the nitrogen gas is not particularly limited, but is preferably 25° C. or more and 120° C. or less, and more preferably 50° C. or more and 70° C. or less.

The pressure (nitrogen partial pressure) at the time of bringing the battery member into contact with the nitrogen gas is not particularly limited, but is preferably 10 kPa or more and 1000 kPa or less, and more preferably 100 kPa or less.

The time when the battery member is brought into contact with the nitrogen gas is not particularly limited, but is preferably 1 hour (h) or more and 100 hours (h) or less, and more preferably 8 hours (h) or more and 24 hours (h) or less.

### 3-3. Treatment Step

In the treatment step S3, the substance containing lithium nitride and sulfide is brought into contact with a treatment liquid containing water. This makes it possible to dissolve the lithium nitride in the treatment liquid and to separate the lithium nitride from the insoluble components such as the active material contained in the battery member.

Specifically, sulfide ions (S²⁻) generated due to the sulfide react with water in the treatment liquid to generate sulfur dioxide ions (SO₂²⁻) as in the following formula (1). Further, the resulting product reacts with water to produce sulfate ions (SO₄²⁻) as in the following formula (2). On the other hand, lithium nitride (Li₃N) reacts with water in the treatment liquid to generate ammonium ions (NH⁴⁺) as represented by the following formula (3). The sulfate ion (SO₄²⁻) generated in the reaction of formula (2) and the ammonium ion (NH⁴⁺) generated in the reaction of formula (3) react as shown in formula (4) to generate ammonium sulfate ((NH₄)₂SO₄).

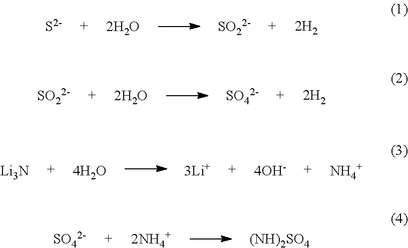

As described above, converting the lithium metal contained in the battery material into lithium nitride in advance in the nitriding step S2 and bringing the lithium nitride into contact with the treatment liquid make it possible to generate ammonium ions (NH⁴⁺) and to react with sulfide ions derived from sulfide, whereby it is possible to effectively suppress the generation of hydrogen sulfide.

The treatment liquid has a function of dissolving the lithium nitride contained in the battery member. Such a treatment liquid contains water, and may contain a protic organic solvent such as alcohol or ketone together with water.

In particular, when the battery member contains a ternary positive electrode material derived from a positive electrode active material of a solid-state battery, or contains copper metal, stainless steel, or aluminum derived from a current collector or the like of a solid-state battery, the treatment liquid is preferably an alkali aqueous solution. Since the ternary positive electrode material, the copper metal, and the stainless steel are not dissolved in the alkali aqueous solution and aluminum is dissolved in a strong alkali aqueous solution, it is possible to selectively dissolve the lithium nitride contained in a substance, which is the treatment object, by bringing the treatment object into contact with the treatment liquid, which is the alkali aqueous solution in a predetermined pH range. In the present disclosure, the alkali aqueous solution that exhibits alkalinity indicates that pH is more than 7.

The pH of the treatment liquid is preferably 7 or more, and more preferably 11 or more. When the substance that is the treatment object contains aluminum derived from a current collector or the like, aluminum dissolves if the treatment liquid is strongly alkaline. Therefore, when the substance that is the treatment object contains aluminum, the pH is preferably 14 or less, and more preferably 13 or less.

As an example of a method for bringing the substance that is the treatment object into contact with a treatment liquid, a method of immersing a battery member in the treatment liquid (immersion method) can be given. With regard to the immersion method, since the contact area between the battery member and the treatment liquid is large, lithium nitride (Li₃N) contained in the substance that is the treatment object can be efficiently dissolved. Furthermore, in a case of the immersion method, it is preferable to stir the treatment liquid.

Another example of the method for bringing the substance that is the treatment object into contact with the treatment liquid is a method of spraying the treatment liquid onto the substance that is the treatment object (spraying method). The spraying method has the advantage of being more suitable for continuous processing than the immersion method described above. In addition, the filtration step can be simultaneously performed by disposing a substance that is the treatment object on a filter and spraying a treatment liquid onto this substance. In the present invention, the heated treatment liquid may be brought into contact with the battery member.

### 2-4. Recovery Step S4

In the recovery step S4, valuable substances such as lithium metal are recovered. Specifically, the insoluble component and the treatment liquid are separated from the mixture of the treatment liquid obtained in the treatment step S3 and the substance that is the treatment object to obtain a treatment liquid in which lithium is dissolved. Specific examples of a method for recovering the insoluble component from the mixture include a filtration method.

The insoluble component mainly includes a positive electrode active material such as a ternary positive electrode material and a metal material derived from a current collector. The insoluble component may include a conductive material, a negative electrode active material different from lithium metal, or the like. Examples of a method for recovering the positive electrode active material from the insoluble component include a method using differences in specific gravity, and specific examples thereof include wind classification, sedimentation classification, centrifugal classification, and the like.

Lithium can be recovered from the treatment liquid separated from the mixture. As a method of recovering lithium from the treatment liquid, it is preferable to recover lithium using a lithium recovery method (LiSMIC) in which an ion conductor is used as a lithium separation membrane. Specifically, the lithium recovery method refers to a method in which a treatment liquid in which lithium is dissolved and a recovery liquid (pure water) are brought into contact with each other via a lithium separation membrane, a voltage is applied to migrate lithium ions to the recovery liquid side to make the recovery liquid into a high purity lithium hydroxide aqueous solution, and carbon dioxide gas is blown into the lithium hydroxide aqueous solution to recover lithium in the form of lithium carbonate (Li₂CO₃). Thus, lithium can be recovered at a high recovery rate.

Examples of another method of recovering lithium from the treatment liquid include a method of recovering lithium as a lithium compound by removing the solvent of the treatment liquid by drying.

When aluminum is contained in the treatment liquid, it is preferable to recover lithium by the above-described method after aluminum is removed by a conventionally known method.

As described above, it is possible for the method for treating a battery member according to the present invention to efficiently recover valuable substances such as lithium metal, while effectively suppressing the generation of hydrogen sulfide, even when a battery member containing sulfide derived from an electrolyte is brought into contact with a treatment liquid.

1. A method for treating a battery member containing lithium metal and a sulfide, the method comprising:
a nitriding step of bringing the battery member into contact with a nitrogen gas to obtain a substance containing lithium nitride and sulfide; and
a treatment step of bringing the substance containing the lithium nitride and the sulfide into contact with a treatment liquid containing water.

2. The method for treating a battery member according to claim 1, wherein
the battery member further contains a ternary positive electrode material, and
the treatment liquid is an alkali aqueous solution.

3. The method for treating a battery member according to claim 1, wherein
the battery member further contains at least one selected from the group consisting of copper metal, stainless steel, and aluminum, and
the treatment liquid is an alkali aqueous solution.

4. The method for treating a battery member according to claim 1, wherein
the battery member is derived from a solid-state battery containing lithium metal and a solid electrolyte containing a sulfide.

5. The method for treating a battery member according to claim 2, wherein
the battery member further contains at least one selected from the group consisting of copper metal, stainless steel, and aluminum, and
the treatment liquid is an alkali aqueous solution.

6. The method for treating a battery member according to claim 2, wherein
the battery member is derived from a solid-state battery containing lithium metal and a solid electrolyte containing a sulfide.
